(19) United States
(12) Patent Application Publication
(10) Pub. No.: US 2024/0305886 A1
(43) Pub. Date: Sep. 12, 2024

(54) CAMERA MODULE, IMAGE CAPTURING METHOD, AND ELECTRONIC DEVICE

(71) Applicant: SONY SEMICONDUCTOR SOLUTIONS CORPORATION, Kanagawa (JP)

(72) Inventors: Hiroshi TAYANAKA, Kanagawa (JP); Norimitsu OKIYAMA, Kanagawa (JP)

(73) Assignee: SONY SEMICONDUCTOR SOLUTIONS CORPORATION, Kanagawa (JP)

(21) Appl. No.: 18/263,363

(22) PCT Filed: Dec. 27, 2021
(86) PCT No.: PCT/JP2021/048508

§ 371 Date: Jul. 28, 2023

(30) Foreign Application Priority Data
Feb. 4, 2021 (JP) 2021-016557

(51) Int. Cl. H04N 23/68

(52) U.S. Cl. CPC H04N 23/683; H04N 23/6812

(57) ABSTRACT

The present technology relates to a camera module, an image capturing method, and an electronic device which enable reduction of a memory capacity required for electronic image stabilization. The camera module includes: an imaging unit that outputs a captured image for each of image blocks each corresponding to a predetermined number of horizontal lines; an image block storage unit that stores the image blocks; and an image correction unit that performs image stabilization for each of the image blocks. The present technology can be applied to, for example, a digital video camera having an electronic image stabilization function.

### TECHNICAL FIELD

The present technology relates to a camera module, an image capturing method, and an electronic device, and more particularly to a camera module, an image capturing method, and an electronic device that perform electronic image stabilization.

### BACKGROUND ART

Representative schemes of image stabilization of ab imaging device are an optical image stabilizer (OIS) and electronic image stabilization (EIS).

Furthermore, as one scheme of the electronic image stabilization, there is a scheme in which image stabilization is performed on the basis of a motion amount obtained from a captured image. In this scheme, however, calculation processing becomes complicated, the measurement accuracy of the motion amount under low illuminance decreases, or an estimation error of a camera shake amount with respect to a moving subject occurs, so that the accuracy of the image stabilization decreases in some cases.

On the other hand, there is proposed electronic image stabilization using motion sensor information acquired by an angular velocity sensor, an acceleration sensor, or the like is proposed (see, for example, Patent Document 1). In the invention described in Patent Document 1, motion of a camera module is detected using the motion sensor information acquired by the angular velocity sensor, the acceleration sensor, or the like, and image stabilization of a captured image is performed for each frame.

### CITATION LIST

### Patent Document

Patent Document 1: International Publication No. 2017/014071

### SUMMARY OF THE INVENTION

### Problems to be Solved by the Invention

In the invention described in Patent Document 1, however, a memory capable of storing a captured image corresponding to at least one frame is required since the image stabilization of the captured image is performed for each frame. Therefore, a memory capacity increases, which leads to, for example, an increase in cost, an increase in an area of large scale integration (LSI), an increase in power consumption, and the like. Furthermore, it is sometimes necessary to install a large cooling fin or cooling fan due to the increase in power consumption.

The present technology has been made in view of such a situation, and an object thereof is to reduce a memory capacity required for electronic image stabilization.

### Solutions to Problems

A camera module according to one aspect of the present technology includes: an imaging unit that outputs a captured image for each of image blocks each corresponding to a predetermined number of horizontal lines; an image block storage unit that stores the image blocks; and an image correction unit that performs image stabilization for each of the image blocks.

An image capturing method according to one aspect of the present technology including: outputting a captured image for each of image blocks each corresponding to a predetermined number of horizontal lines; storing the image blocks; and performing image stabilization for each of the image blocks

An electronic device according to one aspect of the present technology includes: an imaging unit that outputs a captured image for each of image blocks each corresponding to a predetermined number of horizontal lines; an image block storage unit that stores the image blocks; and an image correction unit that performs image stabilization for each of the image blocks.

In one aspect of the present technology, the captured image is output for each of the image blocks each corresponding to a predetermined number of horizontal lines, the image blocks are stored, and the image stabilization is performed for each of the image blocks.

### BRIEF DESCRIPTION OF DRAWINGS

FIG. 1 is a block diagram illustrating a configuration example of one embodiment of a camera module to which the present technology is applied.

FIG. 2 is a block diagram for describing an image stabilization process.

FIG. 3 is a view illustrating an example of driving timings of an image sensor and a motion sensor.

FIG. 4 is a view illustrating an example of output timings of the image sensor.

FIG. 5 is a view illustrating an example of an image block.

FIG. 6 is a view for describing a method of generating an expansion image block.

FIG. 7 is a view illustrating an example of the expansion image block.

FIG. 8 is a view for describing a method of extracting motion data.

FIG. 9 is a view illustrating an example of the method of extracting motion data.

FIG. 10 is a view illustrating an example of the method of extracting motion data.

FIG. 11 is a view for describing a method of calculating a rotational movement amount.

FIG. 12 is a view illustrating an example of an array of pixels of a captured image.

FIG. 13 is a view for describing a method of generating a captured image frame.

FIG. 14 is a view illustrating an example of the captured image frame.

FIG. 15 is a view for describing a process of deforming the captured image frame.

FIG. 16 is a view for describing the process of deforming the captured image frame.

FIG. 17 is a view illustrating an example of an output image frame.

FIG. 18 is a view illustrating an example of a method of setting a cut-out position of the output image.

FIG. 19 is a view in which the output image frame is divided for each frame block.

FIG. 20 is a view illustrating an example of an overlapping state between the output image frame and the frame block.

FIG. 21 is an enlarged view illustrating the example of the overlapping state between the output image frame and the frame block.

FIG. 22 is a view for describing coordinate transformation of the output image.

FIG. 23 is a view for describing the coordinate transformation of the output image.

FIG. 24 is a view for describing an extraction method and an arrangement method for pixel data of the output image.

FIG. 25 is a view for describing the extraction method and the arrangement method for the pixel data of the output image.

FIG. 26 is a view for describing the extraction method and the arrangement method for the pixel data of the output image.

FIG. 27 is a view illustrating an example of an output format of the output image.

FIG. 28 is a view for describing a method of arranging the pixel data of the output image.

FIG. 29 is a view illustrating an example of the output image.

FIG. 30 is a block diagram illustrating a configuration example of one embodiment of an electronic device to which the present technology is applied.

FIG. 31 is a view illustrating a usage example of using the image sensor.

### MODE FOR CARRYING OUT THE INVENTION

Hereinafter, a mode for carrying out the present technology will be described. The description will be given in the following order.
1. Embodiment
2. Modified Examples
3. Others

### <<1. Embodiment>

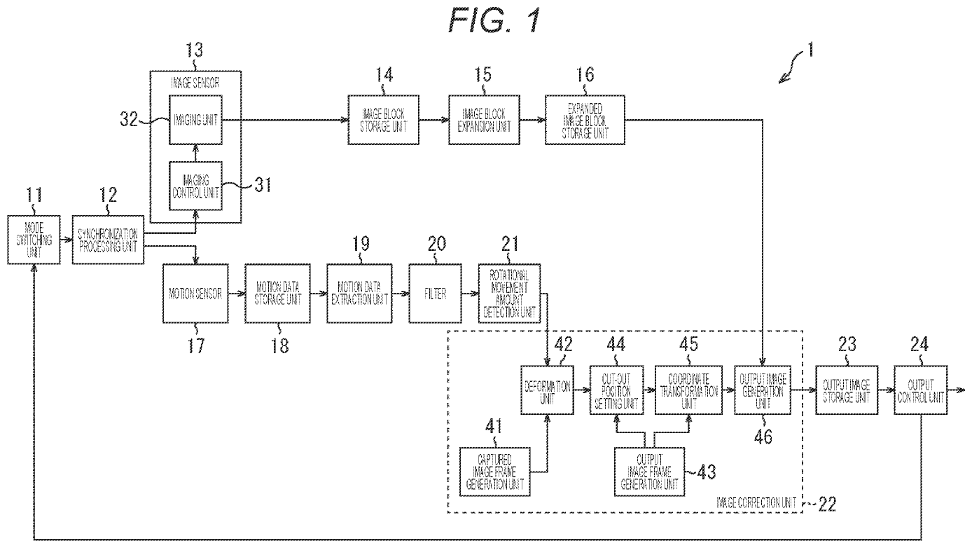

An embodiment of the present technology will be described with reference to FIGS. 1 to 29.

### <Configuration Example of Camera Module 1>

FIG. 1 illustrates an embodiment of a camera module 1 to which the present technology is applied.

The camera module 1 includes a mode switching unit 11, a synchronization processing unit 12, an image sensor 13, an image block storage unit 14, an image block expansion unit 15, an expansion image block storage unit 16, a motion sensor 17, a motion data storage unit 18, a motion data extraction unit 19, a filter 20, a rotational movement amount detection unit 21, an image correction unit 22, an output image storage unit 23, and an output control unit 24.

The mode switching unit 11 switches a driving mode of the camera module 1. There are two driving modes of the camera module 1, that is, a frame blanking mode and an image capturing mode. The frame blanking mode is a mode in which only the motion sensor 17 is driven without driving the image sensor 13 between frames. The image capturing mode is a mode in which both the image sensor 13 and the motion sensor 17 are driven.

The synchronization processing unit 12 controls synchronization between an operation of the image sensor 13 and an operation of the motion sensor 17.

The image sensor 13 is configured using, for example, a CMOS image sensor or the like. The image sensor 13 includes an imaging control unit 31 and an imaging unit 32.

The imaging control unit 31 controls imaging by the imaging unit 32 under the control of the synchronization processing unit 12.

The imaging unit 32 includes a pixel region in which a plurality of pixels is two-dimensionally arranged. The imaging unit 32 performs exposure and output for each block (hereinafter, referred to as pixel block) corresponding to a predetermined number of horizontal lines in the pixel region under the control of the imaging control unit 31. Furthermore, the imaging unit 32 generates an image block including pixel data of pixels in the pixel block, and stores image block data in which a header is added to the head of the image block in the image block storage unit 14. Therefore, a captured image of one frame obtained by imaging is output for each image block and stored in the image block storage unit 14.

The image block expansion unit 15 expands an image block by adding a part of pixel data of adjacent image block data to the image block in the image block data stored in the image block storage unit 14. The image block expansion unit 15 stores the expanded image block (hereinafter, referred to as expansion image block) in the expansion image block storage unit 16.

The motion sensor 17 includes, for example, a six-axis sensor capable of measuring three-axis acceleration and three-axis angular velocity. Note that the motion sensor 17 may further include, for example, a nine-axis sensor capable of further measuring three-axis geomagnetism. The motion sensor 17 generates sensor data (hereinafter, referred to as motion data) indicating a measurement result, and stores the sensor data in the motion data storage unit 18.

The motion data extraction unit 19 extracts motion data to be used to detect a rotational movement amount of the captured image from among pieces of the motion data stored in the motion data storage unit 18, and supplies the extracted motion data to the filter 20.

The filter 20 is configured using, for example, a digital filter such as a moving average filter, an infinite impulse response (IIR) filter, or a finite impulse response (FIR) filter. The filter 20 performs filtering of the motion data and supplies motion data after filtering to the rotational movement amount detection unit 21.

The rotational movement amount detection unit 21 detects the rotational movement amount of the captured image on the basis of the motion data after filtering. The rotational movement amount detection unit 21 supplies data indicating the detected rotational movement amount to a deformation unit 42 of the image correction unit 22.

The image correction unit 22 performs image stabilization on the captured image for each image block. More specifically, the image correction unit 22 performs rotation correction with respect to rotational movement of the captured image for each image block. Furthermore, the image correction unit 22 performs distortion correction on warping distortion of a lens of the camera module 1 for each image block. The image correction unit 22 includes a captured image frame generation unit 41, the deformation unit 42, an output image frame generation unit 43, a cut-out position setting unit 44, a coordinate transformation unit 45, and an output image generation unit 46.

The captured image frame generation unit 41 generates a captured image frame indicating a shape of the captured image, and supplies the captured image frame to the deformation unit 42.

The deformation unit 42 deforms the captured image frame by performing distortion correction on the captured image frame and further performing rotation correction on the basis of the rotational movement amount detected by the rotational movement amount detection unit 21. Therefore, shapes of the captured image deformed by the warping distortion of the lens and the rotational movement and each of the image blocks included in the captured image are calculated. The deformation unit 42 supplies the captured image frame after deformation to the cut-out position setting unit 44.

The output image frame generation unit 43 generates an output image frame indicating a shape of an output image and positions of pixels, and supplies the output image frame to the cut-out position setting unit 44 and the coordinate transformation unit 45.

The cut-out position setting unit 44 sets the output image frame at a position from which the output image is desired to be cut out in the captured image frame after deformation. Therefore, the position to cut out the output image is set in the captured image having the shape calculated by the deformation unit 42. The cut-out position setting unit 44 supplies the captured image frame and data indicating the cut-out position to the coordinate transformation unit 45.

The coordinate transformation unit 45 transforms coordinates of the respective pixels of the output image into coordinates in the captured image, which has been deformed by the warping distortion and rotational movement, on the basis of the captured image frame, the output image frame, and the cut-out position. The coordinate transformation unit 45 supplies data, which indicates the coordinates before transformation and the coordinates after transformation of the respective pixels of the output image, to the output image generation unit 46.

The output image generation unit 46 acquires the expansion image block from the expansion image block storage unit 16. The output image generation unit 46 generates pieces of pixel data of the respective pixels of the output image on the basis of pieces of pixel data of pixels of the expansion image block corresponding to the coordinates after transformation of the respective pixels of the output image. The output image generation unit 46 generates the output image by aligning pieces of the generated pixel data in the output image storage unit 23 in accordance with the coordinates before transformation of the respective pixels of the output image.

The output control unit 24 controls output of the output image stored in the output image storage unit 23 to the outside. The output control unit 24 notifies the mode switching unit 11 of the output of the output image.

### <Image Stabilization Process>

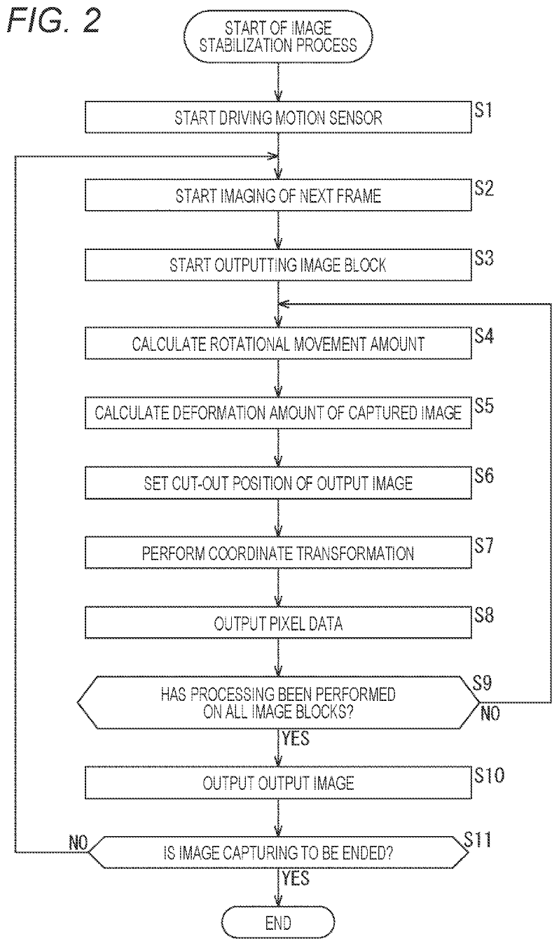

Next, an image stabilization process executed by the camera module 1 will be described with reference to a flowchart of FIG. 2.

In step S1, the camera module 1 starts driving the motion sensor 17. Therefore, the motion sensor 17 starts a process of measuring acceleration and angular velocity of the camera module 1 at a predetermined driving frequency (sampling frequency) and storing motion data indicating measurement results in the motion data storage unit 18.

For example, assuming that the driving frequency of the motion sensor 17 is 4 kHz, the motion sensor 17 measures acceleration and angular velocity and stores motion data every 0.25 ms.

In step S2, the image sensor 13 starts imaging of the next frame.

Specifically, the mode switching unit 11 instructs the synchronization processing unit 12 to switch from the frame blanking mode to the image capturing mode.

The synchronization processing unit 12 starts synchronization between the operation of the image sensor 13 and the operation of the motion sensor 17. For example, the synchronization processing unit 12 synchronizes a horizontal synchronization signal of the image sensor 13 with a driving signal of the motion sensor 17. Therefore, an exposure timing of each of the pixel blocks of the image sensor 13 is synchronized with a measurement timing of the motion sensor 17.

Furthermore, the imaging unit 32 starts exposure of each of the pixel blocks in order from the head pixel block of the pixel region under the control of the imaging control unit 31.

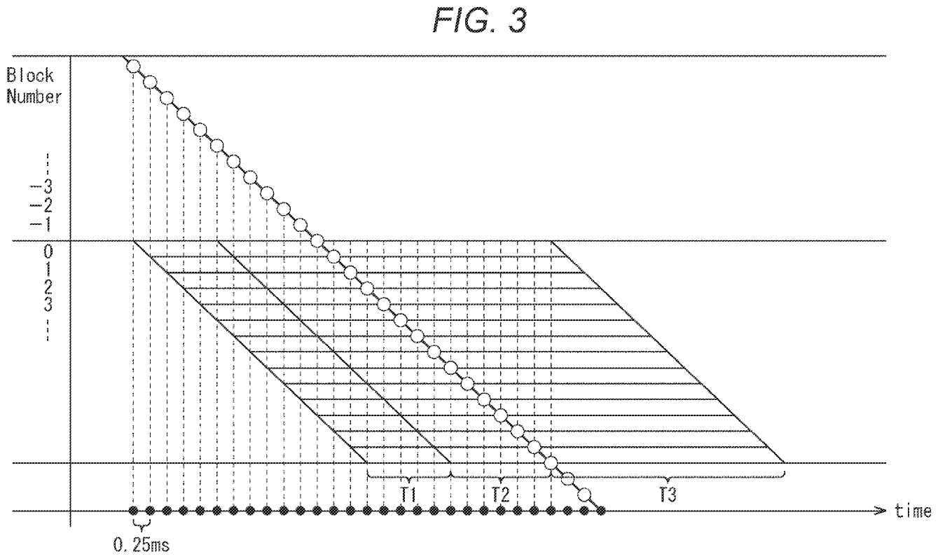

FIG. 3 illustrates an example of driving timings of the image sensor 13 and the motion sensor 17. The horizontal axis represents time. The vertical axis represents a number of a pixel block of the image sensor 13. Note that serial numbers starting from zero are allocated in order from a head pixel block of a pixel region.

A period T1 in the drawing indicates a frame blanking period of each of the pixel blocks of the image sensor 13, that is, a period in which each of the pixel blocks is not driven. A period T2 indicates an exposure period of each of the pixel blocks of the image sensor 13. A period T3 indicates an output period (reading period) of each of the pixel blocks of the image sensor 13. A white circle in the drawing indicates a measurement timing (sampling timing) of the motion sensor 17.

For example, in a case where a frame rate of the image sensor 13 is 30 frames per second (fps) and the driving frequency (sampling frequency) of the motion sensor 17 is 4 kH, the number of samples of motion data per frame is obtained as 4000 kHz/30 fps=133.33 . . . pieces. That is, the number of samples of motion data per frame is 133 or 134 pieces.

Furthermore, for example, in a case where the pixel region of the image sensor 13 is set as 4000 pixels in the vertical direction×4000 pixels in the horizontal direction and the number of horizontal lines of each of the pixel blocks is 40 rows, the pixel region is divided into 100 pixel blocks.

Then, for example, 33 or 34 pieces of motion data are allocated to the frame blanking periods of the image sensor 13, and 100 pieces of motion data are allocated to the exposure periods+the output periods. Therefore, for example, one piece of motion data is allocated to the exposure period+the data output period of each of the pixel blocks.

In step S3, the camera module 1 starts outputting an image block.

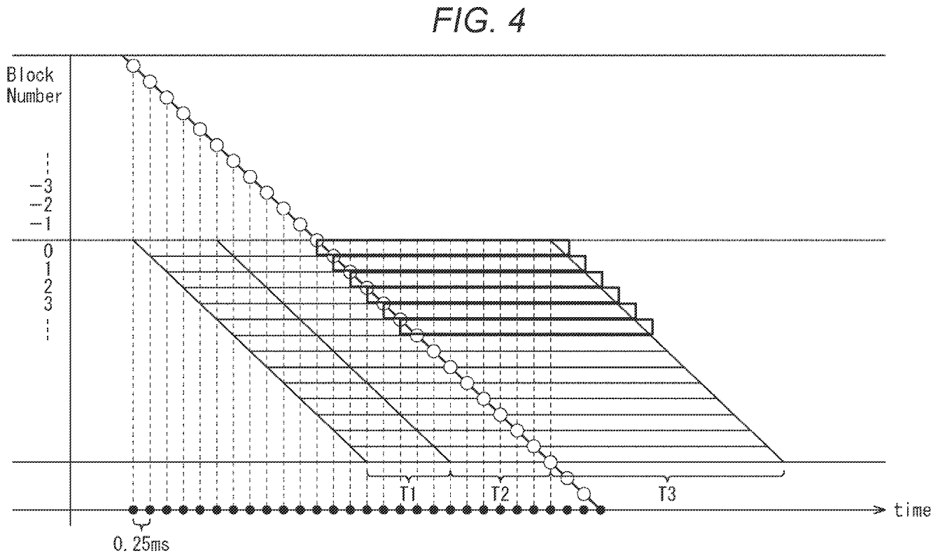

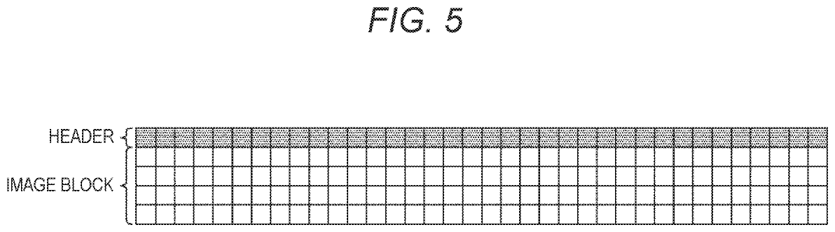

Specifically, for example, as illustrated in FIG. 4, the imaging unit 32 starts a process of reading pixel data of each pixel in units of pixel blocks in order from the head pixel block of the pixel region, and generating an image block including the read pixel data under the control of the imaging control unit 31. Furthermore, the imaging unit 32 starts a process of generating image block data illustrated in FIG. 5 and storing the image block data in the image block storage unit 14.

Here, the image block data includes a header and an image block.

The header includes, for example, a frame number, a number of the image block, an exposure condition, a pixel size, and the like.

The image block includes the pixel data of each of the pixels in the corresponding pixel block.

Furthermore, the image block expansion unit 15 starts a process of generating an expansion image block on the basis of each piece of the image block data stored in the image block storage unit 14. The image block expansion unit 15 starts a process of storing the generated expansion image block in the expansion image block storage unit 16.

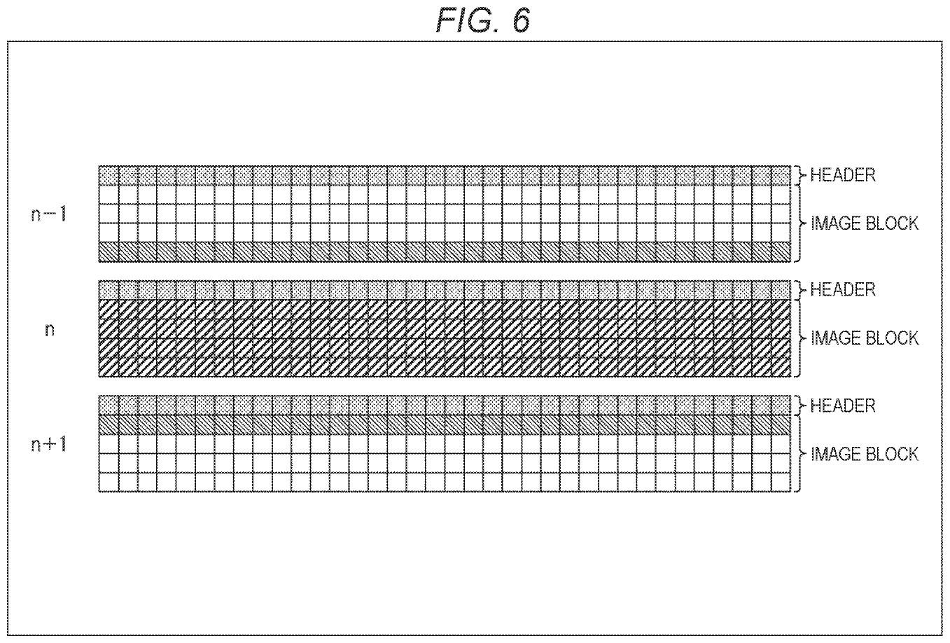

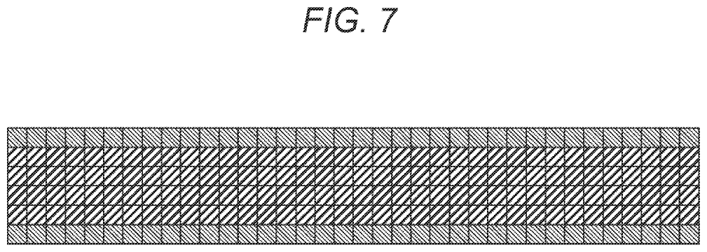

Here, a method of generating an expansion image block will be described with reference to FIGS. 6 and 7.

FIG. 6 illustrates pieces of image block data including the (n−1)-th to (n+1)-th image blocks, respectively. FIG. 7 illustrates an example of an expansion image block obtained by expanding the n-th image block.

The image block expansion unit 15 removes a header from the n-th image block data. Furthermore, the image block expansion unit 15 adds pixel data, included in a predetermined number of rows (for example, two rows) of horizontal lines at the end of the previous ((n−1)-th) image block, to the head of the n-th image block. Moreover, the image block expansion unit 15 adds pixel data, included in a predetermined number of rows (for example, two rows) of horizontal lines at the head of the subsequent ((n+1)-th) image block, to the end of the n-th image block.

As a result, the expansion image block obtained by expanding horizontal lines at the head and the end of the n-th image block is generated as illustrated in FIG. 7.

Note that pixel data of expanded portions of an expansion image block is used, for example, for color interpolation of pixel data in an image block before expansion.

Furthermore, the image block expansion unit 15 first generates an expansion image block corresponding to a head image block of a captured image, and stores the expansion image block in the expansion image block storage unit 16. Thereafter, every time the expansion image block stored in the expansion image block storage unit 16 is read, the image block expansion unit 15 generates an expansion image block corresponding to the next image block and stores the expansion image block in the expansion image block storage unit 16.

In step S4, the camera module 1 calculates a rotational movement amount. Specifically, the motion data extraction unit 19 reads motion data corresponding to an image block as an image stabilization target from the motion data storage unit 18. Note that image blocks are set as image stabilization targets sequentially from the head image block of the captured image.

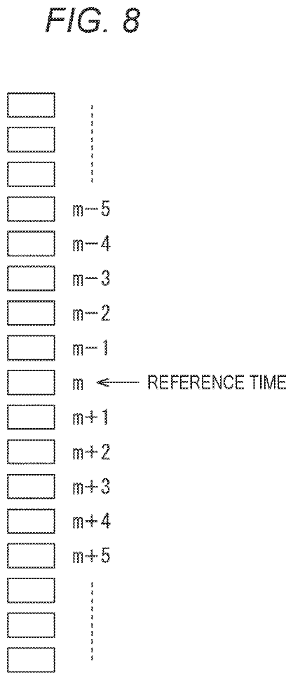

For example, in a case where the n-th image block is an image stabilization target, the motion data extraction unit 19 sets, for example, time at the center of an exposure period of a pixel block corresponding to the n-th image block as reference time. For example, as illustrated in FIG. 8, the motion data extraction unit 19 reads a predetermined number of pieces of motion data before and after motion data (hereinafter, referred to as reference motion data) acquired at the time closest to the reference time from the motion data storage unit 18.

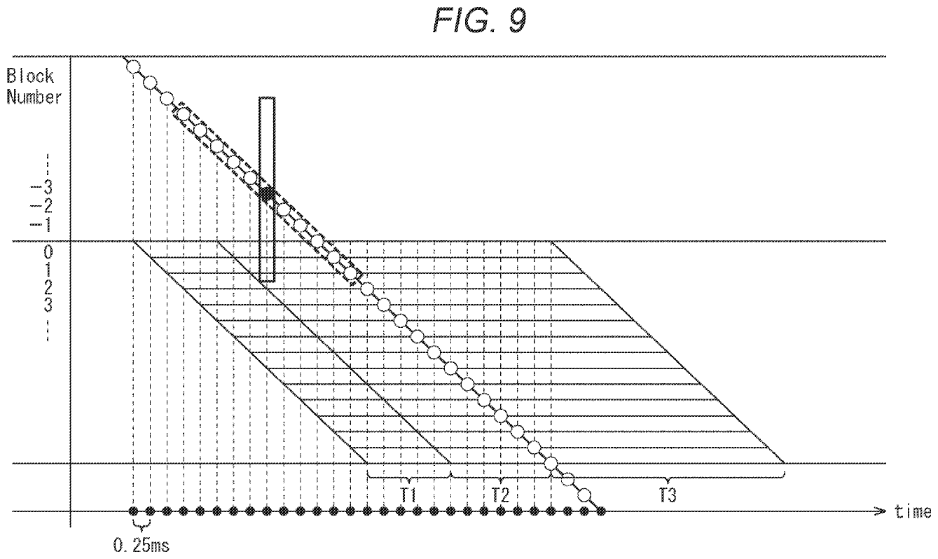

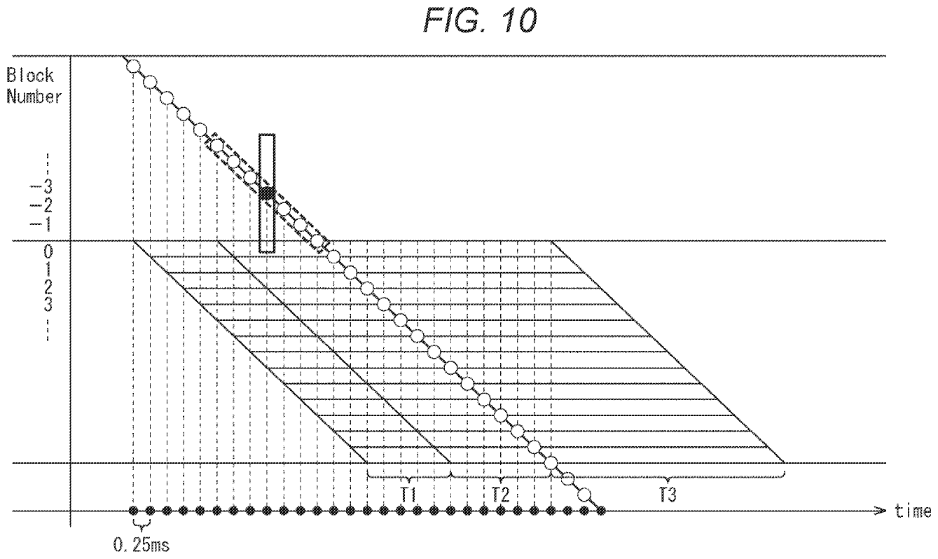

FIGS. 9 and 10 illustrate examples of extraction of motion data corresponding to a pixel block with Number 0 (hereinafter, referred to as Pixel Block 0). Note that motion data indicated by the black circle in FIGS. 9 and 10 indicates reference motion data.

FIG. 9 illustrates an example in which a total of 11 pieces of motion data including reference motion data, 5 pieces before the reference motion data, and 5 pieces after the reference motion data are extracted. FIG. 10 illustrates an example in which a total of 7 pieces of motion data including reference motion data, 3 pieces before the reference motion data, and 3 pieces after the reference motion data are extracted.

The motion data extraction unit 19 supplies the extracted motion data to the filter 20.

The filter 20 filters the extracted motion data by a predetermined scheme, and supplies filtered motion data to the rotational movement amount detection unit 21.

Note that the motion data storage unit 18 is provided with memories equal to or more than the number of pieces of the motion data used in the filter 20.

The rotational movement amount detection unit 21 calculates the rotational movement amount of the captured image (the image sensor 13) on the basis of the motion data after filtering. A method of calculating the rotational movement amount is not particularly limited, but for example, an Euler method, a quaternion method, or the like is used.

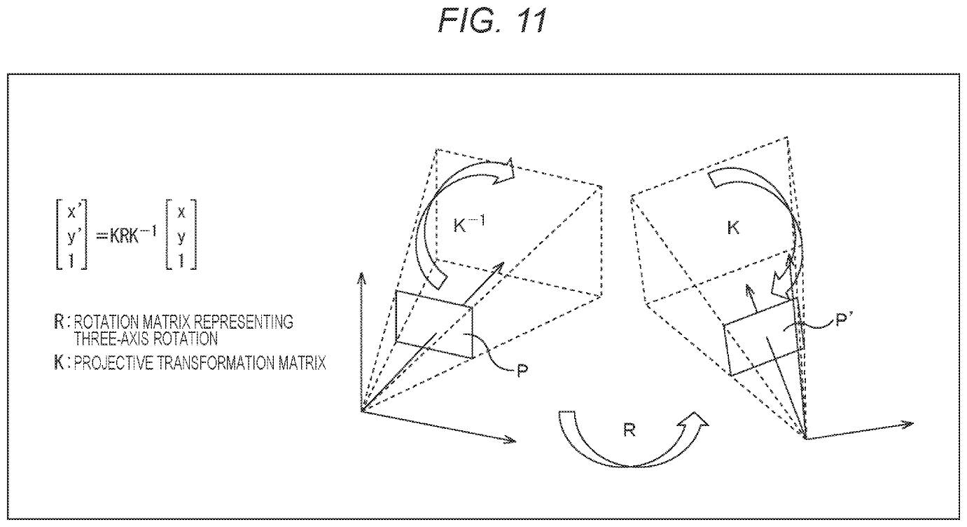

For example, as illustrated in FIG. 11, a rotation matrix R, a projective transformation matrix K, and a projective transformation matrix K⁻¹ for transforming a coordinate of each pixel of a captured image P before rotational movement into a coordinate of each pixel of an image P′ after rotational movement are calculated. Here, the rotation matrix R, the projective transformation matrix K, and the projective transformation matrix K⁻¹ are expressed by the following Formula (1).

$$[ Formula 1 ]$$

$$\begin{matrix}R = {R}_{x} ( {θ}_{pitch} ) {R}_{y} ( {θ}_{yaw} ) {R}_{z} ( {θ}_{roll} ) \\ = [ \begin{matrix}1 & 0 & 0 \\ 0 & cos ( {θ}_{pitch} ) & sin ( {θ}_{pitch} ) \\ 0 & - sin ( {θ}_{pitch} ) & cos ( {θ}_{pitch} )\end{matrix} ] [ \begin{matrix}cos ( {θ}_{yaw} ) & 0 & - sin ( {θ}_{yaw} ) \\ 0 & 1 & 0 \\ sin ( {θ}_{yaw} ) & 0 & cos ( {θ}_{yaw} )\end{matrix} ] [ \begin{matrix}cos ( {θ}_{roll} ) & sin ( {θ}_{roll} ) & 0 \\ - sin ( {θ}_{roll} ) & cos ( {θ}_{roll} ) & 0 \\ 0 & 0 & 1\end{matrix} ]\end{matrix} \qquad ( 1 )$$

$$K = [ \begin{matrix}{f}_{x} & 0 & {x}_{c} \\ 0 & {f}_{y} & {y}_{c} \\ 0 & 0 & 1\end{matrix} ]$$

$${K}^{- 1} = [ \begin{matrix}1 / {f}_{x} & 0 & - {x}_{c} / {f}_{x} \\ 0 & 1 / {f}_{y} & - {y}_{c} / {y}_{X} \\ 0 & 0 & 1\end{matrix} ]$$

[fₓ, f_{y}]: x-direction focal length, y-direction focal length
[xₓ, y_{y}]: x-direction optical center, y-direction optical center

A rotation angle of the image sensor 13 in a pitch direction in a camera coordinate system is denoted by θ_{pitch}, a rotation angle of the image sensor 13 in a roll direction in the camera coordinate system is denoted by θᵣₒₗₗ, and a rotation angle of the image sensor 13 in a yaw direction in the camera coordinate system is denoted by θ_{yaw}. A focal length in an x-axis direction (horizontal direction) of the camera coordinate system is denoted by fₓ, a focal length in the y-axis direction (vertical direction) of the camera coordinate system is denoted by f_{y}, an optical center in the x-axis direction of the camera coordinate system is denoted by x_{c}, and an optical center in the y-axis direction of the camera coordinate system is denoted by y_{c}.

The rotational movement amount detection unit 21 supplies data indicating the calculated rotational movement amount to the deformation unit 42.

In step S5, the camera module 1 calculates a deformation amount of the captured image.

First, the captured image frame generation unit 41 generates a captured image frame and supplies the generated captured image frame to the deformation unit 42.

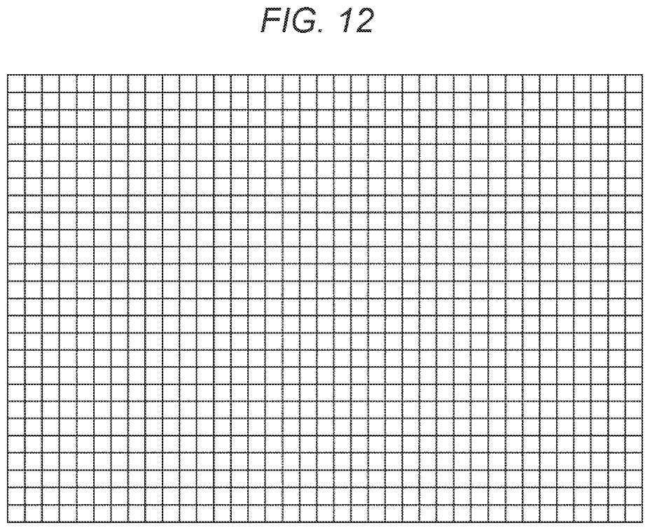

Specifically, FIG. 12 illustrates an array of pixels of the captured image. Here, the captured image is represented by a smaller number of pixels (25 pixels in the vertical direction×37 pixels in the horizontal direction) than the actual number of pixels in order to simplify the description.

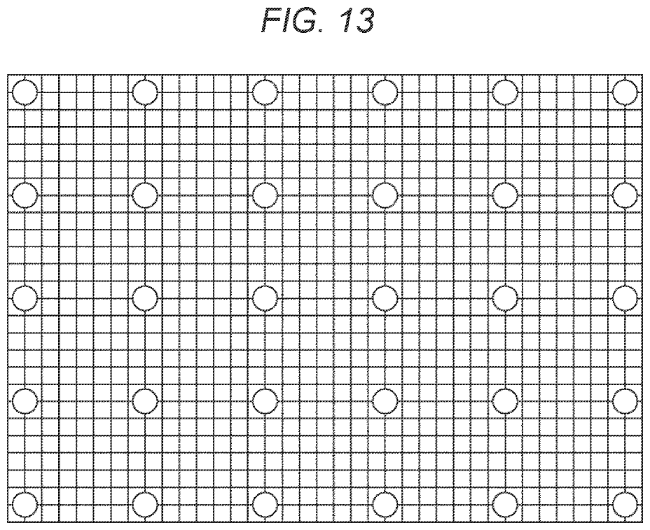

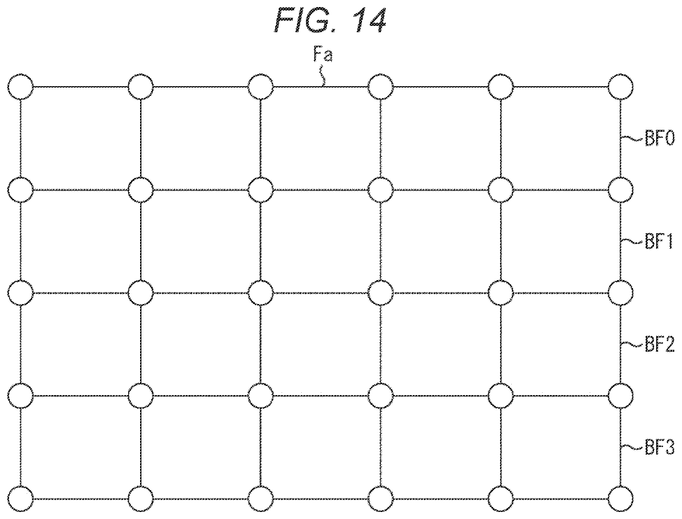

The captured image frame generation unit 41 sets frame points constituting a captured image frame Fa between pixels of the captured image at predetermined intervals as illustrated in FIG. 13. In this example, the frame points are set at intervals of six pixels in the vertical direction and at intervals of seven pixels in the horizontal direction. Then, the captured image frame generation unit 41 generates the captured image frame Fa having a mesh shape by connecting adjacent frame points with straight lines as illustrated in FIG. 14.

Note that the captured image frame Fa is divided similarly to the image blocks of the captured image. Note that, hereinafter, it is assumed that the captured image is divided into four image blocks, and the captured image frame Fa is divided into four frame blocks BF0 to BF3 corresponding to the image blocks, respectively, in order to simplify the description.

Note that, hereinafter, the frame blocks BF0 to BF3 will be simply referred to as frame blocks BF in a case where they do not need to be distinguished from each other.

Furthermore, a coordinate of each of the frame points is represented by a coordinate on an image coordinate system of the captured image. For example, the coordinate of each of the frame points is represented by a coordinate in a case where a coordinate of a pixel at the upper left corner of the captured image is set as the origin of the image coordinate system.

The deformation unit 42 deforms the captured image frame. Specifically, the deformation unit 42 reflects warping distortion of a lens (not illustrated) of the camera module 1 on the captured image frame Fa. In this deformation process, for example, distortion correction parameters of the open source computer vision library (OpenCV) are used.

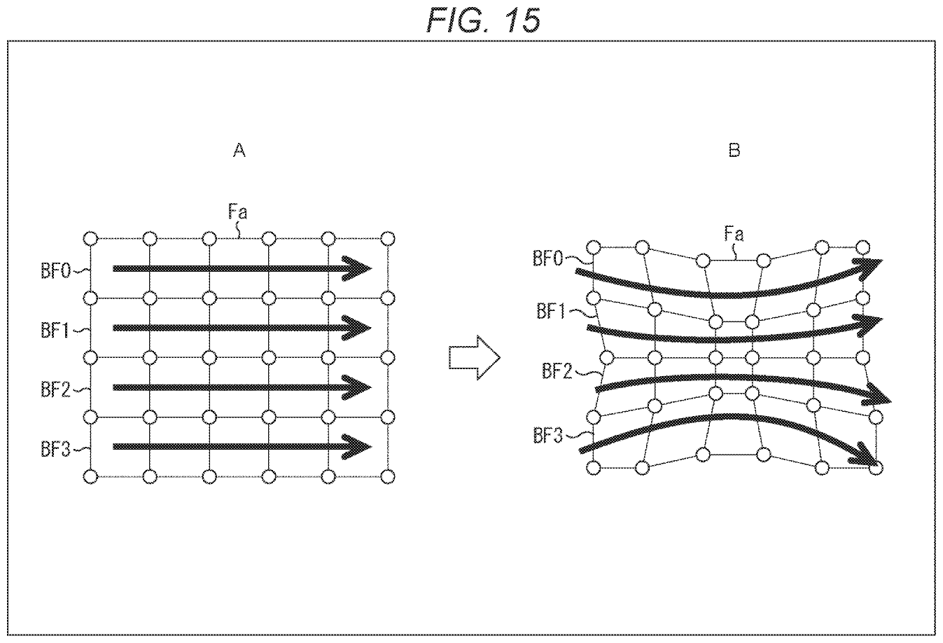

Therefore, for example, the captured image frame Fa illustrated in A of FIG. 15 is deformed into the captured image frame Fa illustrated in B of FIG. 15 by reflecting the warping distortion of the lens of the camera module 1. The captured image frame Fa after deformation indicates a shape of the captured image in a case where the warping distortion has been reflected in the captured image. Furthermore, each of the frame blocks BF after deformation indicates a shape of an image block in a case where the warping distortion has been reflected on each of the image blocks of the captured image.

Next, the deformation unit 42 deforms the captured image frame Fa by performing rotational movement of the captured image frame. Specifically, the deformation unit 42 rotationally moves the captured image frame Fa by the rotational movement amount calculated by the rotational movement amount detection unit 21 using the above-described rotation matrix R, projective transformation matrix K, and projective transformation matrix K⁻¹.

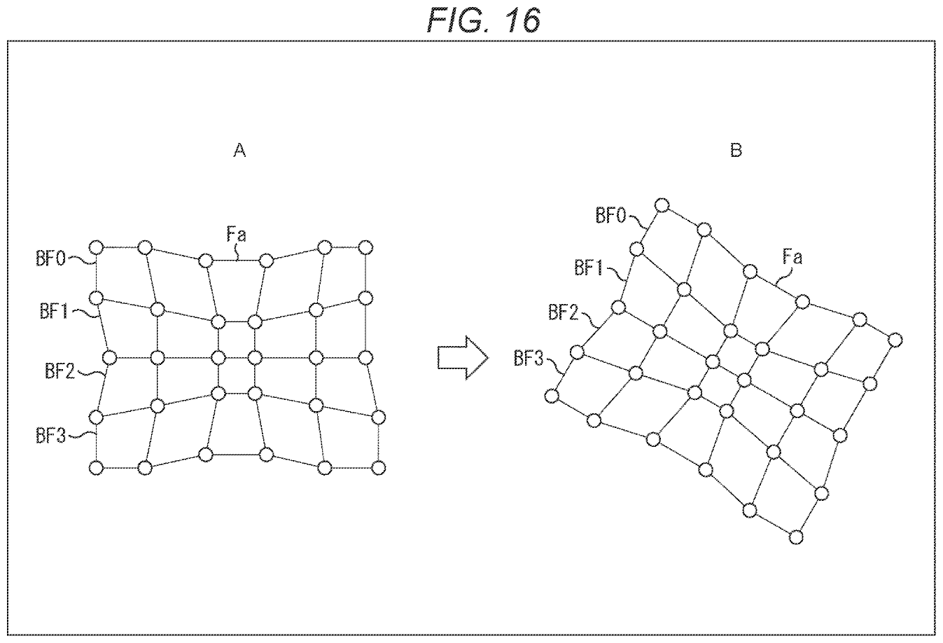

Therefore, for example, the captured image frame Fa in A of FIG. 16 is deformed into the captured image frame Fa illustrated in B of FIG. 16 by reflecting the movement and deformation due to the rotational movement of the image sensor 13. The captured image frame Fa after deformation indicates a shape and a position of the captured image in a case where the warping distortion and the rotational movement have been reflected on the captured image. Furthermore, each of the frame blocks BF after deformation indicates a shape and a position of an image block in a case where the warping distortion and the rotational movement have been reflected on each of the image blocks of the captured image.

The deformation unit 42 supplies the captured image frame Fa after deformation to the cut-out position setting unit 44.

In step S6, the cut-out position setting unit 44 sets a cut-out position of an output image.

Specifically, first, the output image frame generation unit 43 generates an output image frame and supplies the output image frame to the cut-out position setting unit 44 and the coordinate transformation unit 45.

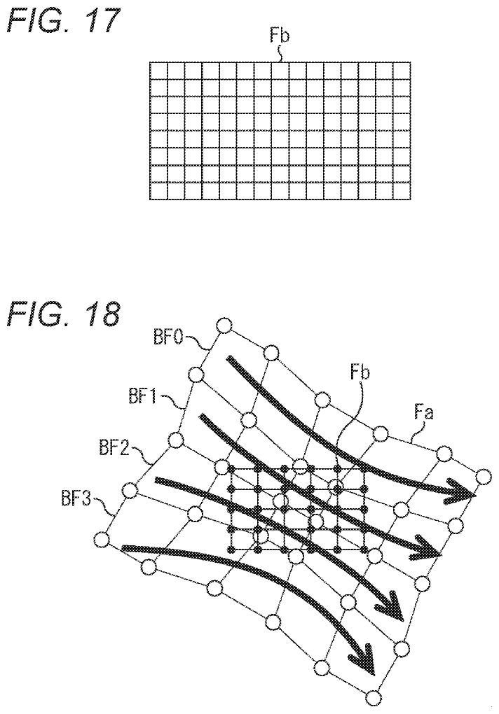

FIG. 17 illustrates an example of an output image frame Fb. As described above, the output image frame Fb is a frame indicating a shape of the output image and positions of pixels. Here, a cut-out image is represented by a smaller number of pixels (8 pixels in the vertical direction×15 pixels in the horizontal direction) than the actual number of pixels in order to simplify the description.

Note that a coordinate of each of the pixels of the output image frame Fb is set independently of the captured image frame Fa. For example, a coordinate of a pixel at the upper left corner of the output image frame Fb is set as the origin.

Next, as illustrated in FIG. 18, the cut-out position setting unit 44 sets the output image frame Fb at a position from which the output image is to be cut out in the captured image frame Fa after deformation.

Note that the output image frame Fb is set at, for example, a predetermined position of the output image frame Fb before deformation (for example, the center of the output image frame Fb before deformation). Therefore, the cut-out position of the output image is set to a predetermined position in the image coordinate system of the captured image.

As a result, the position from which the output image is to be cut out is set in the captured image deformed by the warping distortion and the rotational movement.

The cut-out position setting unit 44 supplies the captured image frame Fa and data indicating the set cut-out position to the coordinate transformation unit 45.

In step S7, the coordinate transformation unit 45 performs coordinate transformation. Specifically, the coordinate transformation unit 45 transforms coordinates of the pixels of the output image frame into coordinates in the captured image frame after deformation. More specifically, the coordinate transformation unit 45 transforms the coordinates of the pixels of the output image frame included in the frame block corresponding to the image block as the image stabilization target into the coordinates in the frame block after deformation.

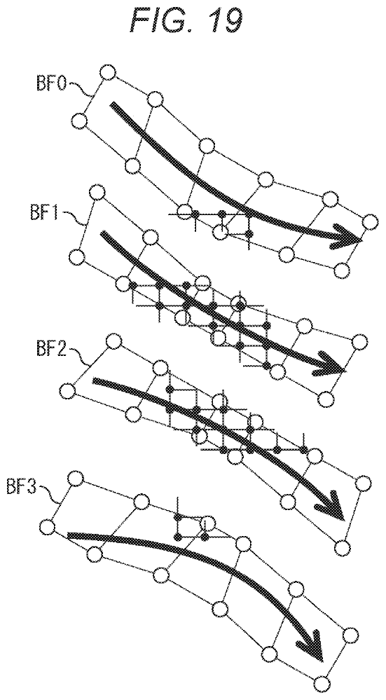

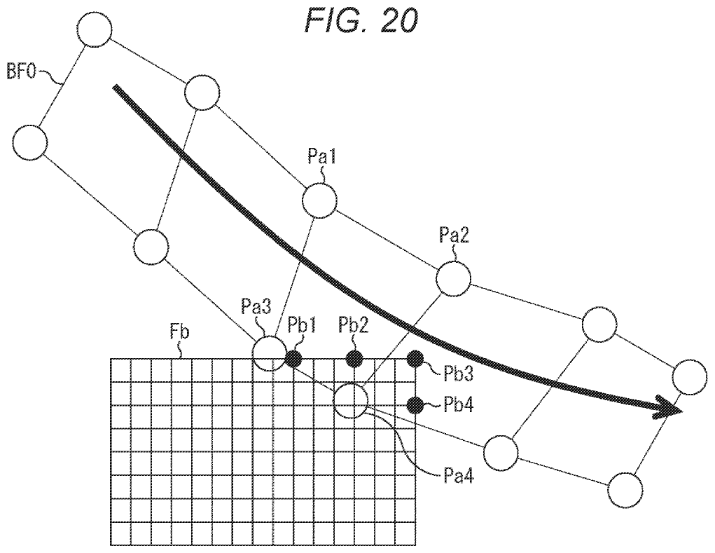

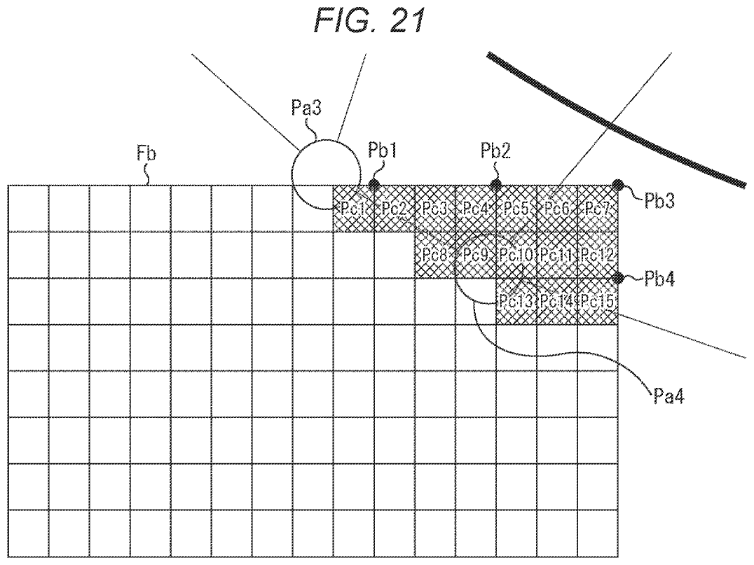

FIG. 19 is a view in which the output image frame Fb is divided for each region included in each of the frame blocks BF of the captured image frame Fa. FIG. 20 is a view illustrating an overlapping state between the frame block BF0 and the output image frame Fb. FIG. 21 is an enlarged view of a portion where the frame block BF0 and the output image frame Fb overlap in FIG. 20. As illustrated in FIG. 21, pixels Pc1 to Pc15 of the output image frame Fb are included in the frame block BF0 in this example.

For example, in a case where an image block corresponding to the frame block BF0 is an image stabilization target, the coordinate transformation unit 45 transforms coordinates of the pixels Pc1 to Pc15 of the output image frame Fb included in the frame block BF0 into coordinates in the frame block BF0.

For example, first, the coordinate transformation unit 45 transforms coordinates of intersection points Pb1 to Pb4, obtained by appropriately thinning intersection points between the pixels of the output image frames Fb illustrated in FIGS. 20 and 21, into coordinates in the frame block BF0.

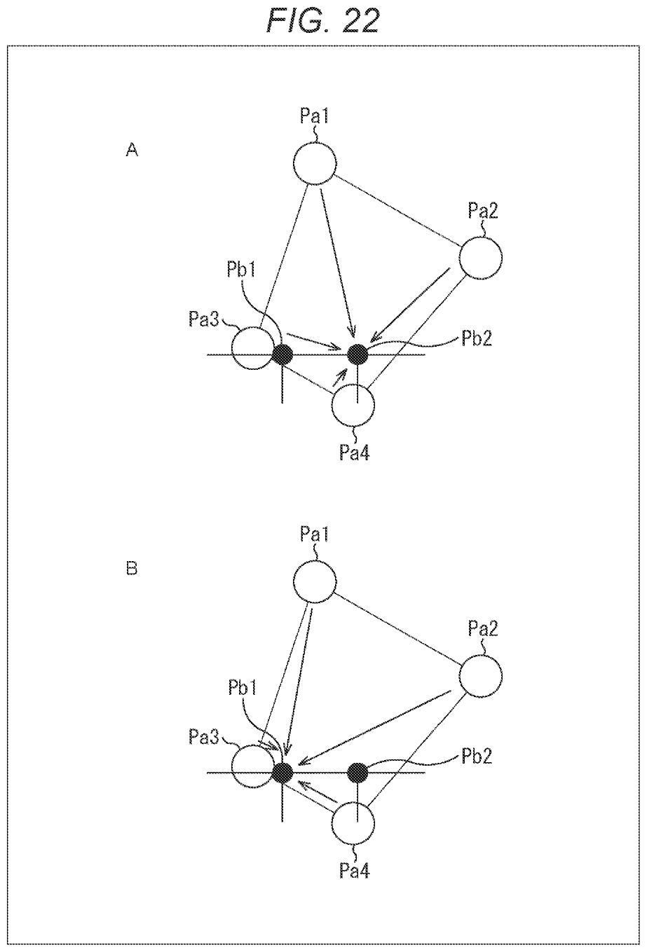

For example, as illustrated in A of FIG. 22, the intersection point Pb2 of the output image frame Fb is included in a region surrounded by frame points Pa1 to Pa4 of the frame block BF0. Then, the coordinate transformation unit 45 calculates the coordinate of the intersection point Pb2 in the frame block BF0 on the basis of coordinates of the frame points Pa1 to Pa4 and distances of the intersection point Pb2 from the frame points Pa1 to Pa4.

For example, as illustrated in B of FIG. 22, the intersection point Pb1 of the output image frame Fb is included in the region surrounded by frame points Pa1 to Pa4 of the frame block BF0. Then, the coordinate transformation unit 45 calculates the coordinate of the intersection point Pb1 in the frame block BF0 on the basis of the coordinates of the frame points Pa1 to Pa4 and distances of the intersection point Pb1 from the frame points Pa1 to Pa4.

Note that coordinates in the captured image frame Fa before deformation, that is, coordinates in the captured image before deformation are used as the coordinates of the frame points Pa1 to Pa4.

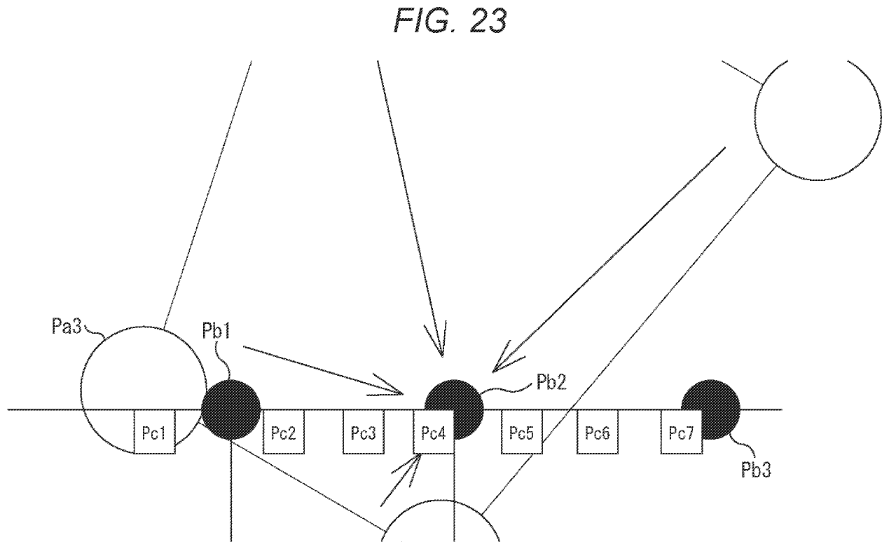

Next, the coordinate transformation unit 45 calculates the coordinates of the pixels Pc1 to Pc15 in the frame block BF0 on the basis of the coordinates of the intersection points Pb1 to Pb4 after transformation. For example, as illustrated in FIG. 23, the coordinates of the pixels Pc1 to Pc7 in the frame block BF0 are calculated on the basis of the coordinates of the intersection points Pb1 to Pb3 after transformation.

Here, the positional relationship between each of the intersection points Pb1 to Pb4 and each of the pixels Pc1 to Pc15 is known. Therefore, the amount of calculation is smaller in a case where the coordinates of the pixels Pc1 to Pc15 are calculated on the basis of the coordinates of the intersection points Pb1 to Pb4 after transformation than a case where coordinate transformation of the pixels Pc1 to Pc15 is directly performed. Such an effect of reducing the amount of calculation increases as the number of pixels of the output image frame Fb increases.

Note that, for example, the coordinate transformation unit 45 may directly perform the coordinate transformation of the pixels Pc1 to Pc15 without performing the coordinate transformation of the intersection points Pb1 to Pb4.

As a result, the coordinates in the frame block BF0 of the respective pixels of the output image frame Fb included in the deformed frame block BF0 are calculated. That is, coordinates of pixels included in an image block corresponding to the deformed frame block BF0 among the pixels of the output image are transformed into coordinates in the image block.

The coordinate transformation unit 45 supplies data indicating coordinates before transformation and coordinates after transformation of the respective pixels of the output image frame, set as a transformation target, to the output image generation unit 46.

In step S8, the output image generation unit 46 outputs pixel data. For example, the output image generation unit 46 reads an expansion image block corresponding to the image block as the image stabilization target from the expansion image block storage unit 16.

The output image generation unit 46 generates pieces of pixel data of the respective pixels of the output image frame on the basis of pixel data of pixels of the expansion image block corresponding to the coordinates after transformation of the respective pixels of the output image frame set as the transformation target in the processing in step S7.

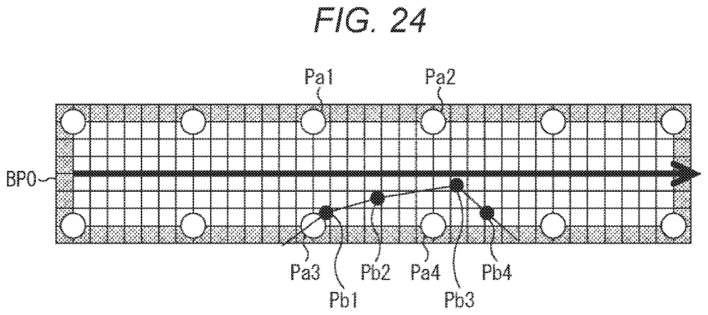

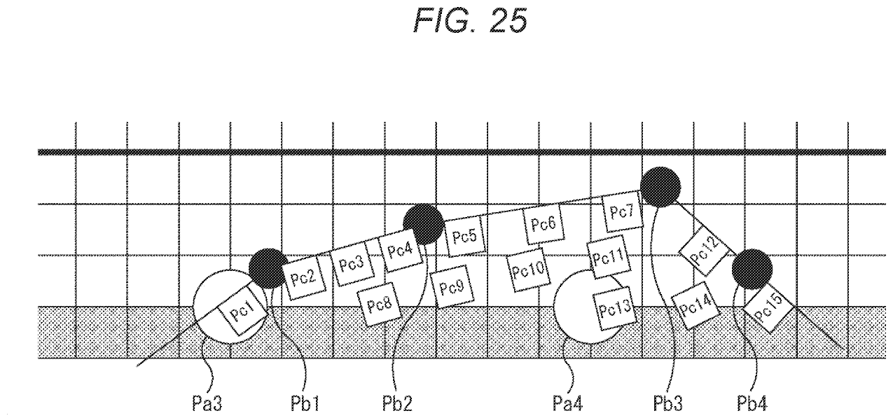

For example, FIG. 24 illustrates an example in which the intersection points Pb1 to Pb4 of the output image frames Fb are arranged in an expansion image block BP0 including the image block corresponding to the frame block BF0 on the basis of the coordinates after transformation. FIG. 25 is an enlarged view of the periphery of the intersection points Pb1 to Pb4 in FIG. 24, and illustrates an example in which the pixels Pc1 to Pc15 of the output image frame Fb are arranged in the expansion image block BP0 on the basis of the coordinates after transformation.

For example, pixel data of a pixel at a position where the pixel Pc1 of the expansion image block BP0 is arranged is extracted as pixel data of the pixel Pc1. Pieces of pixel data of the other pixels of the output image frame Fb are similarly extracted from the expansion image block BP0.

Furthermore, the output image generation unit 46 performs color interpolation of the pixel data of the pixel of the output image frame Fb as necessary.

For example, in a case where pixels of an output image are arranged according to the Bayer array, extracted pixel data includes only information about one color among red (R), green (G), and blue (B). Furthermore, for example, there is a case where coordinates after transformation of pixels of an output image frame do not match coordinates of pixels of an expansion image block. In other words, there is a case where each of the pixels of the output image frame after coordinate transformation is arranged between the pixels of the expansion image block.

In regard to this, for example, the output image generation unit 46 interpolates color information of pixel data of each of pixels on the basis of pixel data of pixels around a position where each of the pixels of the output image frame is arranged in the expansion image block.

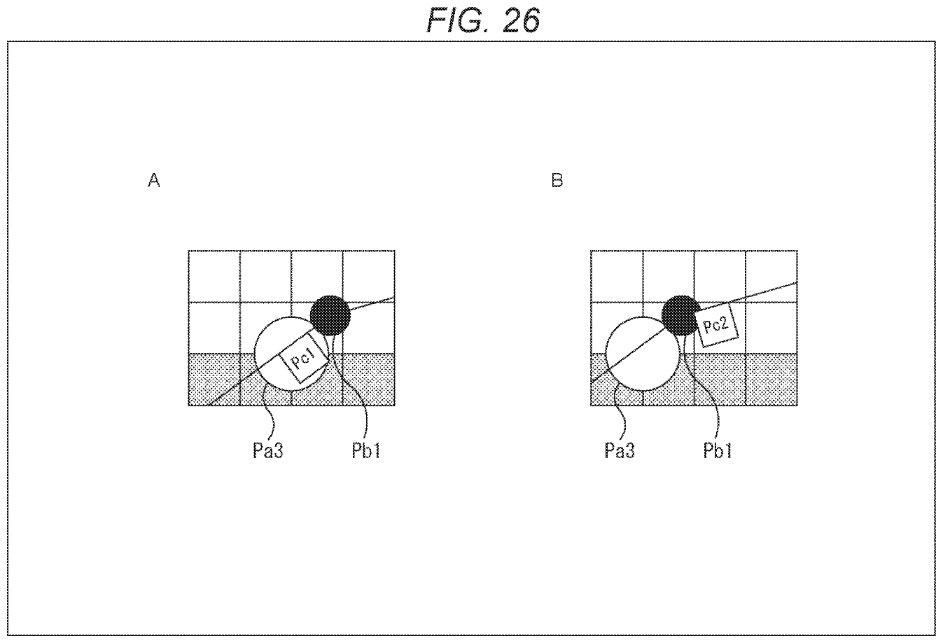

For example, as illustrated in A of FIG. 26, color information of pixel data of the pixel Pc1 is interpolated on the basis of pixel data of pixels around a position where the pixel Pc1 is arranged in the expansion image block BP0. For example, as illustrated in B of FIG. 26, color information of pixel data of the pixel Pc2 is interpolated on the basis of pixel data of pixels around a position where the pixel Pc2 is arranged in the expansion image block BP0.

Furthermore, the output image generation unit 46 arranges pieces of the pixel data of the respective pixels of the output image frame in the output image storage unit 23 in accordance with the coordinates before transformation.

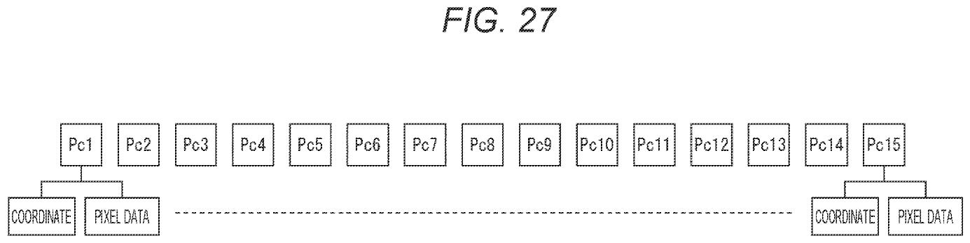

For example, as illustrated in FIG. 27, the output image generation unit 46 supplies pixel information (for example, the color information or the like) including pieces of the pixel data of the pixels Pc1 to Pc15 of the output image frame and the coordinates before transformation to the output image storage unit 23. Then, the output image generation unit 46 arranges pieces of the pixel data of the pixels Pc1 to Pc15 in the output image storage unit 23 in accordance with the coordinates before transformation.

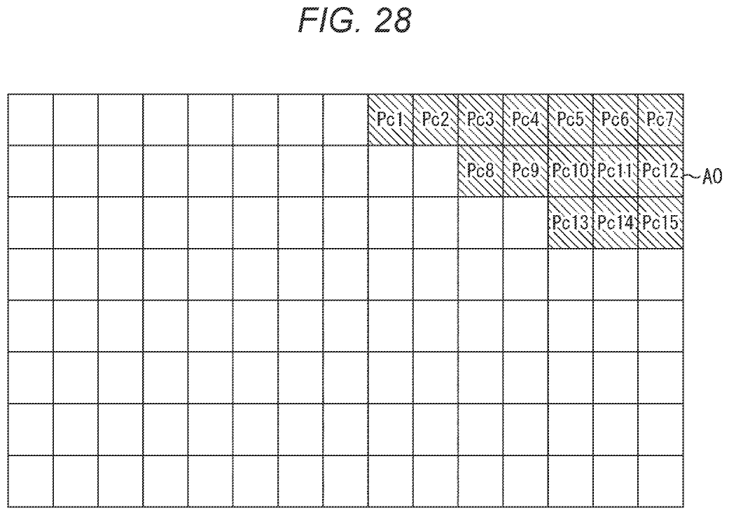

FIG. 28 illustrates an example of the output image stored in the output image storage unit 23. For example, pieces of the pixel data of the output image frame generated by the output image generation unit 46 are arranged in Region A0 of the output image in accordance with the coordinates before transformation.

In step S9, the output image generation unit 46 determines whether or not processing has been performed on all image blocks. In a case where there still remains an image block that has not been subjected to the image stabilization process among the image blocks in the captured image set as the image stabilization targets, the output image generation unit 46 determines that the processing has not been performed on all the image blocks, and the processing returns to step S4.

Thereafter, the processing of steps S4 to S9 is repeatedly executed until it is determined in step S9 that the processing has been performed on all the image blocks.

Therefore, the image stabilization is performed for each of the image blocks. That is, a rotational movement amount is detected for each of the image blocks, and a coordinate of each of pixels of an output image is transformed into a coordinate in the image block deformed by warping distortion and rotational movement. Furthermore, pixel data of a pixel of the image block at the coordinate after transformation is extracted, color interpolation is performed on the extracted pixel data, and the pixel data is arranged in accordance with the coordinate before transformation of the output image.

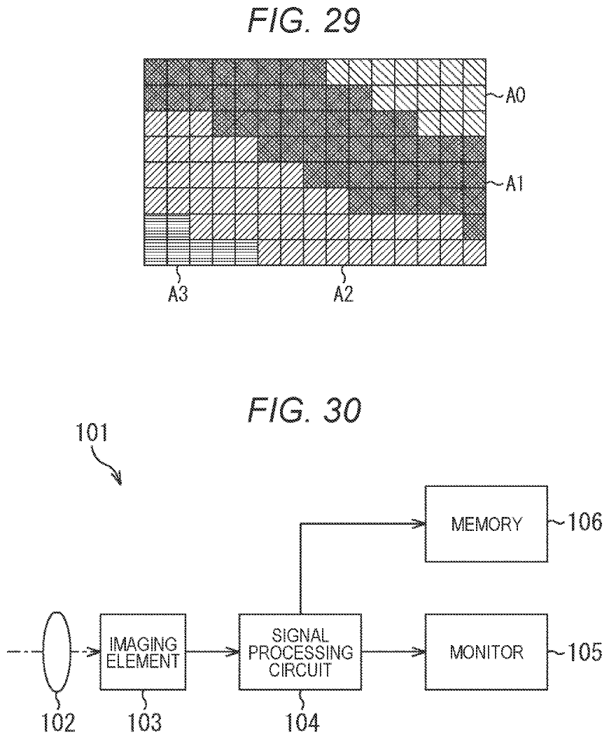

FIG. 29 illustrates an example of the output image. In this manner, pieces of pixel data extracted from the expansion image blocks BP0 to BP3 are arranged in Regions A0 to A3 of the output image indicated by different patterns.

As a result, the output image in which the warping distortion and the rotational movement of the captured image have been corrected is acquired.

On the other hand, in a case where it is determined in step S9 that the processing has been performed on all the image blocks, the processing proceeds to step S10.

In step S10, the output control unit 24 outputs the output image. Specifically, the output control unit 24 reads the output image from the output image storage unit 23 and outputs the output image to the outside. Furthermore, the output control unit 24 notifies the mode switching unit 11 of completion of the output of the output image.

In step S11, the camera module 1 determines whether or not to end image capturing. In a case where it is determined not to end the image capturing, the processing returns to step S2, and the processing from steps S2 to S11 is repeatedly executed until it is determined to end the image capturing in step S11.

Meanwhile, for example, in a case where an operation to end the image capturing has been performed on an operation unit (not illustrated), the camera module 1 determines to end the image capturing in step S11, and the image capturing process ends.

Since the warping distortion and the rotational movement are corrected for each of the image blocks as described above, it is possible to obtain the output image in which the warping distortion and the rotational movement have been corrected.

Furthermore, since the warping distortion and the rotational movement are corrected in units of pixel blocks, the capacity of the image block storage unit 14 can be reduced, for example, as compared with a case where the correction is performed in units of frames. Therefore, for example, LSI used for the camera module 1 can be downsized. Furthermore, power consumption is reduced, and heat generation decreases. Therefore, it is possible to downsize or reduce cooling fins or fans. As a result, the camera module 1 can be downsized. Moreover, cost of the camera module 1 is decreased.

### <<2. Modified Examples>

Hereinafter, modified examples of the above-described embodiment of the present technology will be described.

For example, the flowchart of FIG. 2 illustrates an example in which the rotational movement amount of the captured image is detected for each image block, and the detected rotational movement is corrected. However, for example, a rotational movement amount of a captured image may be detected for each frame, and the detected rotational movement may be corrected. That is, a rotational movement amount may be detected once for image blocks in the same frame, and the rotation of each of the image blocks may be corrected on the basis of the same rotational movement amount.

For example, the distortion correction may be omitted, and only the rotation correction may be performed.

For example, the output image frame generation unit 43 may generate the output image frame reflecting the warping distortion of the lens in advance.

For example, the output image generation unit 46 may supply the pixel information of each of the pixels of the output image illustrated in FIG. 27 to the output control unit 24 without storing the pixel information in the output image storage unit 23, and the output control unit 24 may output the pixel information of each of the pixels of the output image to the outside. In this case, the output image is generated outside the camera module 1 by aligning pieces of the pixel data of the respective pixels on the basis of the coordinate data in the pixel information of the respective pixels of the output image.

### <<3. Others>

### <Configuration Example of Electronic Device>

Note that the camera module 1 according to the above-described embodiment can be applied to various electronic devices, for example, an imaging system such as a digital still camera or a digital video camera, a mobile phone having an imaging function, or another device having an imaging function.

FIG. 30 is a block diagram illustrating a configuration example of an imaging device mounted on an electronic device.

As illustrated in FIG. 30, an imaging device 101 includes an optical system 102, an imaging element 103, a signal processing circuit 104, a monitor 105, and a memory 106, and can capture a still image and a moving image.

The optical system 102 includes one or a plurality of lenses, guides image light (incident light) from a subject to the imaging element 103, and forms an image on a light receiving surface (sensor unit) of the imaging element 103.

As the imaging element 103, the camera module 1 of the above-described embodiment is applied. Electrons are accumulated in the imaging element 103 for a certain period in accordance with the image formed on the light receiving surface via the optical system 102. Then, a signal corresponding to the electrons accumulated in the imaging element 103 is supplied to the signal processing circuit 104.

The signal processing circuit 104 performs various types of signal processing on a pixel signal output from the imaging element 103. An image (image data) obtained by the signal processing applied by the signal processing circuit 104 is supplied to the monitor 105 to be displayed or supplied to the memory 106 to be stored (recorded).

In the imaging device 101 configured in this manner, for example, an image in which camera shake and lens distortion are corrected can be captured more accurately by applying the camera module 1 of the above-described embodiment.

### <Use Examples of Image Sensor>

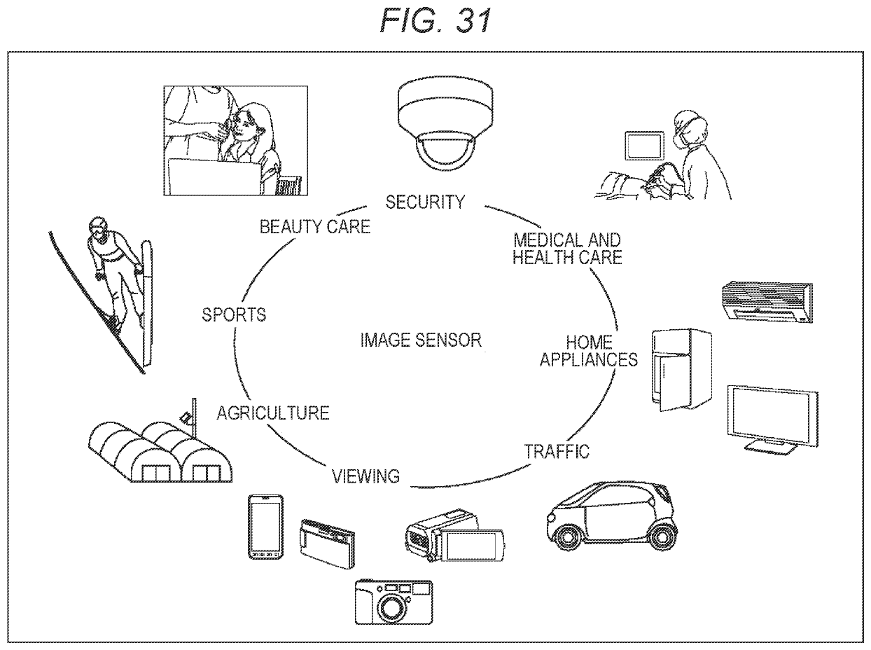

FIG. 31 is a view illustrating a usage example of using the image sensor 13 of the camera module 1 described above.

The image sensor 13 described above can be used in various cases for sensing light such as visible light, infrared light, ultraviolet light, and X-ray as described below, for example.
A device that captures an image to be used for viewing, such as a digital camera and a portable device with a camera function.
A device used for traffic purpose such as an in-vehicle sensor that captures images of the front, rear, surroundings, interior and the like of an automobile, a monitoring camera for monitoring traveling vehicles and roads, or a ranging sensor which measures a distance between vehicles and the like for safe driving such as automatic stop, recognition of a condition of a driver, and the like.
A device used for home appliances such as a television, a refrigerator, and an air conditioner in order to capture an image of a gesture of a user and perform device operation according to the gesture
A device used for medical and health care such as an endoscope and a device that performs angiography by receiving infrared light
A device used for security, such as a monitoring camera for a crime prevention application or a camera for a person authentication application
A device used for beauty care, such as a skin measuring instrument that captures an image of a skin or a microscope that captures an image of a scalp
A device used for sports such as an action camera or a wearable camera for sports applications.
A device used for agriculture such as a camera for monitoring conditions of fields and crops.

### <Combination Examples of Configurations>

The present technology can also have the following configurations.
(1)
A camera module including:
an imaging unit that outputs a captured image for each of image blocks each corresponding to a predetermined number of horizontal lines;
an image block storage unit that stores the image blocks; and
an image correction unit that performs image stabilization for each of the image blocks.
(2)
The camera module according to (1), further including
a rotational movement amount detection unit that detects a rotational movement amount of the captured image, in which
the image correction unit performs rotation correction for each of the image blocks on the basis of the detected rotational movement amount.
(3)
The camera module according to (2), in which
the image correction unit includes:
a deformation unit that calculates shapes of the captured image, which has been deformed by rotational movement, and the image block on the basis of the detected rotational movement amount;
a cut-out position setting unit that sets a position from which an output image is to be cut out in the captured image having the calculated shape;
a coordinate transformation unit that transforms a coordinate of a pixel of the output image into a coordinate in the image block having the calculated shape; and
an output image generation unit that generates pixel data of the output image on the basis of pixel data of a pixel of the image block corresponding to the coordinate after transformation.
(4)
The camera module according to (3), in which
the output image generation unit aligns the pixel data of the output image in accordance with the coordinate before transformation.
(5)
The camera module according to (3), further including
an output control unit that controls output of pixel information including the pixel data of each pixel of the output image and the coordinate before transformation.
(6)
The camera module according to any one of (3) to (5), in which
the deformation unit calculates a shape of the captured image, deformed by warping distortion of a lens of the camera module and rotational movement, and a shape of the image block.
(7)
The camera module according to any one of (3) to (6), in which
the output image generation unit performs color interpolation of the pixel data of the output image on the basis of pieces of pixel data of pixels around the pixel of the image block corresponding to the coordinate after transformation.
(8)
The camera module according to (2), in which
the image correction unit further corrects warping distortion of a lens of the camera module for each of the image blocks.
(9)
The camera module according to any one of (2) to (8), further including
a motion sensor that detects acceleration and angular velocity, in which
the rotational movement amount detection unit detects the rotational movement amount of the captured image on the basis of sensor data from the motion sensor.
(10)
The camera module according to (9), in which
the rotational movement amount detection unit detects the rotational movement amount for each of the image blocks, and
the image correction unit performs rotation correction of each of the image blocks on the basis of the rotational movement amount detected for each of the image blocks.
(11)
The camera module according to (10), in which
the rotational movement amount detection unit detects the rotational movement amount on the basis of a plurality of pieces of the sensor data acquired by the motion sensor before and after a center of an exposure period of the image block.
(12)
The camera module according to (9), in which
the rotational movement amount detection unit detects the rotational movement amount for each of frames, and
the image correction unit performs rotation correction of the image block on the basis of the rotational movement amount detected for each of the frames.
(13)
The camera module according to any one of (1) to (8), in which
the imaging unit performs exposure and output for each of pixel blocks each corresponding to the predetermined number of horizontal lines in a pixel region.
(14)
The camera module according to (13), further including:
a motion sensor that detects acceleration and angular velocity; and
a synchronization processing unit that synchronizes a measurement timing of the motion sensor with an exposure timing of each of the pixel blocks.
(15)
An image capturing method including:
outputting a captured image for each of image blocks each corresponding to a predetermined number of horizontal lines;
storing the image blocks; and
performing image stabilization for each of the image blocks
(16)
An electronic device including:
an imaging unit that outputs a captured image for each of image blocks each corresponding to a predetermined number of horizontal lines;
an image block storage unit that stores the image blocks; and
an image correction unit that performs image stabilization for each of the image blocks.

Note that the effects described in the present specification are merely examples and are not limited, and other effects may be provided.

### REFERENCE SIGNS LIST

1 Camera module
12 Synchronization processing unit
13 Image sensor
14 Image block storage unit
16 Image block expansion unit
17 Motion sensor
19 Motion data extraction unit
21 Rotational movement amount detection unit
22 Image correction unit
23 Output image storage unit
41 Captured image frame generation unit
42 Deformation unit
43 Output image frame generation unit
44 Cut-out position setting unit
45 Coordinate transformation unit
46 Output image generation unit
101 Imaging device
102 Optical system
103 Imaging element

What is claimed is:

1. A camera module, comprising:
an imaging unit that outputs a captured image for each of image blocks each corresponding to a predetermined number of horizontal lines;
an image block storage unit that stores the image blocks; and
an image correction unit that performs image stabilization for each of the image blocks.

2. The camera module according to claim 1, further comprising
a rotational movement amount detection unit that detects a rotational movement amount of the captured image, wherein
the image correction unit performs rotation correction for each of the image blocks on a basis of the detected rotational movement amount.

3. The camera module according to claim 2, wherein
the image correction unit includes:
a deformation unit that calculates shapes of the captured image, which has been deformed by rotational movement, and the image block on a basis of the detected rotational movement amount;
a cut-out position setting unit that sets a position from which an output image is to be cut out in the captured image having the calculated shape;
a coordinate transformation unit that transforms a coordinate of a pixel of the output image into a coordinate in the image block having the calculated shape; and
an output image generation unit that generates pixel data of the output image on a basis of pixel data of a pixel of the image block corresponding to the coordinate after transformation.

4. The camera module according to claim 3, wherein
the output image generation unit aligns the pixel data of the output image in accordance with the coordinate before transformation.

5. The camera module according to claim 3, further comprising
an output control unit that controls output of pixel information including the pixel data of each pixel of the output image and the coordinate before transformation.

6. The camera module according to claim 3, wherein
the deformation unit calculates a shape of the captured image, deformed by warping distortion of a lens of the camera module and rotational movement, and a shape of the image block.

7. The camera module according to claim 3, wherein
the output image generation unit performs color interpolation of the pixel data of the output image on a basis of pieces of pixel data of pixels around the pixel of the image block corresponding to the coordinate after transformation.

8. The camera module according to claim 2, wherein
the image correction unit further corrects warping distortion of a lens of the camera module for each of the image blocks.

9. The camera module according to claim 2, further comprising
a motion sensor that detects acceleration and angular velocity, wherein
the rotational movement amount detection unit detects the rotational movement amount on a basis of sensor data from the motion sensor.

10. The camera module according to claim 9, wherein
the rotational movement amount detection unit detects the rotational movement amount for each of the image blocks, and
the image correction unit performs rotation correction of each of the image blocks on a basis of the rotational movement amount detected for each of the image blocks.

11. The camera module according to claim 10, wherein
the rotational movement amount detection unit detects the rotational movement amount on a basis of a plurality of pieces of the sensor data acquired by the motion sensor before and after a center of an exposure period of the image block.

12. The camera module according to claim 9, wherein
the rotational movement amount detection unit detects the rotational movement amount for each of frames, and
the image correction unit performs rotation correction of the image block on a basis of the rotational movement amount detected for each of the frames.

13. The camera module according to claim 1, wherein
the imaging unit performs exposure and output for each of pixel blocks each corresponding to the predetermined number of horizontal lines in a pixel region.

14. The camera module according to claim 13, further comprising:
a motion sensor that detects acceleration and angular velocity; and
a synchronization processing unit that synchronizes a measurement timing of the motion sensor with an exposure timing of each of the pixel blocks.

15. An image capturing method, comprising:
outputting a captured image for each of image blocks each corresponding to a predetermined number of horizontal lines;
storing the image blocks; and
performing image stabilization for each of the image blocks.

16. An electronic device, comprising:
an imaging unit that outputs a captured image for each of image blocks each corresponding to a predetermined number of horizontal lines;
an image block storage unit that stores the image blocks; and
an image correction unit that performs image stabilization for each of the image blocks.
